(19) United States
(12) Patent Application Publication
(10) Pub. No.: US 2024/0342991 A1
(43) Pub. Date: Oct. 17, 2024

(54) ADDITIVE MANUFACTURING APPARATUS HAVING A CARTRIDGE CONTAINING RODS OF MODELLING MATERIAL AND CARTRIDGE FOR SUCH AN APPARATUS

(71) Applicant: BOND HIGH PERFORMANCE 3D TECHNOLOGY B.V., Enschede (NL)

(72) Inventors: Marald SPEELMAN, Enschede (NL); Klaas GROEN, Enschede (NL); Gerard Folkert MULDER, Enschede (NL); Kevin Hendrik Jozef VOSS, Enschede (NL); Martijn Johannes WOLBERS, Enschede (NL)

(21) Appl. No.: 18/292,081

(22) PCT Filed: Jul. 26, 2022
(86) PCT No.: PCT/EP2022/070871

§ 371 Date: Jan. 25, 2024

(30) Foreign Application Priority Data
Jul. 30, 2021 (NL) 2028896

(51) Int. Cl. B29C 64/321; B29C 64/259; B33Y 30/00

(52) U.S. Cl. CPC B29C 64/321; B29C 64/259; B33Y 30/00

(57) ABSTRACT

An apparatus for forming a three-dimensional object by additive manufacturing, in particular extrusion based modelling, including a printhead for depositing modelling material and a base constituting a support for the three-dimensional object to be printed by the printhead. The printhead and the base are moveable with respect to each other for positioning and moving the printhead with respect to the base to form the three-dimensional object. The apparatus furthermore includes a cartridge containing rods of solid modelling material, and a feeding device adapted to feed the rods of modelling material from the cartridge to the printhead. The cartridge is adapted to be placed on the feeding device.

### BACKGROUND OF THE INVENTION

The invention relates to an apparatus for forming a three-dimensional object by additive manufacturing, in particular extrusion based modelling, said apparatus comprising:
a printhead for depositing modelling material,
a base constituting a support for the three-dimensional object to be printed by the printhead,
wherein the printhead and the base are moveable with respect to each other for positioning and moving the printhead with respect to the base to form the three-dimensional object,
said apparatus furthermore comprising:
a cartridge containing rods of solid modelling material,
a feeding device adapted to feed the rods of modelling material from the cartridge to the printhead.

US 2020/0307069 discloses an additive manufacturing device or a 3D printer, which generates a 3D component layer by layer. The additive manufacturing device comprises a material magazine in which a plurality of profile rods is stored. The profile rods are pre-tailored and are adapted to the component layer by layer. The profile rods, when printing, are successively retrieved from the material magazine and, by way of an infeed installation, guided to the nozzle of the additive manufacturing installation and subsequently applied to the printing bed so as to form the component layer by layer.

WO 2016/142472 discloses an additive manufacturing apparatus in which rods contained in a cartridge are fed to a printhead.

US 2018/0311899 discloses a cartridge for dispensing rods within a 3D printing system. The cartridge has a housing in which rods are stacked horizontally. The cartridge has a roller disposed at the housing exit. The roller has a slot and is configured to receive a rod in the slot as the roller rotates in the housing and dispense the rod from the slot as the slot rotates towards the housing exit.

In many extrusion based additive manufacturing processes, such as fused deposition modelling (FDM) or 3D printing, modelling materials may be used which are hygroscopic. An example of such a hygroscopic modelling material is PEEK, which is a well-known and commonly used thermoplastic modelling material, but which is highly hygroscopic. Moist in environmental air is absorbed by the PEEK, which thereby becomes unsuitable for 3D printing of high quality components.

Furthermore, modelling materials, such as PEEK, are preferably kept as pure as possible to ensure a 3D printing process obtaining high quality components. Therefore, such materials are often provided in the form of straight rods of a limited length which do not require additives in the modelling material to make the material bendable such as weakening agents, which are by contrast necessary in modelling material provided in filament coils.

### SUMMARY OF THE INVENTION

The invention has for an object to provide an apparatus for forming a three-dimensional object by additive manufacturing, which allows an efficient supply of high quality modelling material.

This object is achieved by an apparatus for forming a three-dimensional object by additive manufacturing, in particular extrusion based modelling, said apparatus comprising:
a printhead for depositing modelling material,
a base constituting a support for the three-dimensional object to be printed by the printhead,
wherein the printhead and the base are moveable with respect to each other for positioning and moving the printhead with respect to the base to form the three-dimensional object,
said apparatus furthermore comprising:
a cartridge containing rods of solid modelling material,
a feeding device adapted to feed the rods of modelling material from the cartridge to the printhead,
wherein the cartridge is adapted to be placed on the feeding device.

The cartridge in the apparatus according to the invention is a separate part, which the user may purchase from a modelling material supplier, and which is then placed in the additive manufacturing apparatus. If the cartridge is empty, or another modelling material is required the cartridge can be replaced by a new cartridge.

In a preferred embodiment the feeding device comprises a docking section and the cartridge has a discharging end, wherein the docking section is adapted to receive the discharging end of the cartridge. The user can easily set the discharging end of the cartridge in the docking section. In a further embodiment the docking section of the feeding device comprises a latch to retain the cartridge on the feeding device. The latch may be operable by the user.

In a preferred further embodiment, the docking section of the feeding device and/or the discharging end of the cartridge comprises a seal which seals the interior of the cartridge from the environmental air. The cartridge is filled by the material supplier with rods in a dry state. Thereto the rods may be dried before they are put in the cartridge, or they may be dried when they are in the cartridge.

The cartridge may be delivered to the purchaser in a sealing container, e.g. a sealing bag, such that the cartridge is shielded from environmental air and moist. In such a state the cartridge may be preserved for a longer period.

Preferably the cartridge is hermetically sealed. Thereby the cartridge itself can shield the rods contained therein from the environmental air and moist, e.g. once the cartridge is removed from a sealing container.

Furthermore, the cartridge may contain a desiccant. The desiccant absorbs any moist that may enter the cartridge during use and facilitates in keeping the material dry and thus maintaining the quality of the material and the formed 3D object.

In a possible embodiment, the cartridge is adapted to be flushed with dry gas. Thereto the cartridge may have a connection port for connecting a dry gas source to the cartridge. The cartridge also may have a flush outlet port. The dry gas source may be incorporated in the apparatus but may also be on a separate location. The dry gas flushes along the rods and any moist that has entered the cartridge during use is flushed away. Moreover, the flushing dry gas has a drying effect on the rods in the cartridge.

In an embodiment the apparatus has a discharge mechanism that is operable by an actuating mechanism on the feeding device to discharge rods individually from the cartridge. A batch of rods is located in the cartridge and the discharge mechanism allows to individualize the rods from the batch in order to feed an individual rod to the printhead, while the remaining rods of the batch remain in the cartridge, which, as mentioned in the above, preferably maintains the remaining rods sealed from environmental air and moist.

In a further embodiment the cartridge comprises an air lock, said air lock having a closed state in which it seals the interior of the cartridge from the environment, and said airlock having a temporary open state when the actuating mechanism of the feeding device discharges a rod from the cartridge. The airlock is designed to advantageously minimize the amount of environmental air and moist that enters the cartridge when an individual rod is discharged from the cartridge.

In a further embodiment the discharge mechanism comprises a movable extractor on the feeding device and a gate on the feeding device, and wherein the cartridge has a cartridge outlet which is aligned with the gate when the cartridge is placed on the feeding device, wherein the movable extractor is introduced in the cartridge through the gate and through the cartridge outlet when the cartridge is placed on the feeding device, said movable extractor comprising a rod chamber to extract an individual rod from the cartridge.

In a further embodiment the airlock comprises a stop surface surrounding the gate and a shoulder formed on the extractor, said shoulder being adapted to engage the stop surface when the extractor is introduced through the gate, and wherein the airlock furthermore comprises a seal provided on the stop surface or the shoulder to seal the gate in an airtight manner when the extractor is introduced through the gate. Thus, when the cartridge is placed on the feeding device, the extractor enters the cartridge, but at the same time the engagement between the shoulder of the extractor and the stop surface prevents environmental air and moist to enter the interior of the cartridge in cooperation with the seal around the gate.

In a further embodiment the feeding device includes a compression spring which biases the extractor so as to extend into the cartridge and to bias the shoulder of the extractor towards the stop surface. The compression spring warrants the automatic sealing between the extractor and the surface around the gate.

In a further embodiment the extractor is movable to a discharge position, in which the extractor is at least partially withdrawn from the gate whereby a rod received in the rod chamber is moved through the gate and is allowed to be discharged through the ejection port of the feeding device, and in which the airlock is in the temporarily open state.

In a further embodiment the actuator mechanism includes an actuating member, e.g. an actuator pin, which is connected to the movable extractor, which actuating member is adapted to be pushed down so as to push the extractor to the discharge position. This pushing down may for example be done by a lever mechanism which will be described in the following.

Another aspect of the invention relates to the feature that the cartridge comprises a magazine in which the rods are stacked in a parallel fashion, and wherein the rods are oriented substantially horizontal when the cartridge is placed on the feeding device. One advantage of the horizontal orientation of the rods in the use modus is that the movement of the rods towards the discharge end of the cartridge can be gravity based, which prevents the necessity of an actively controlled push mechanism to move the rods within the magazine towards the discharge end.

The stacked rods in the cartridge may remain in an unwanted stable arch structure after some rods have been discharged from the cartridge. Thereby the stack of rods gets stuck inside the magazine and rods will not fall automatically towards the exit.

A further embodiment tackles this problem. In this embodiment a movable slider is arranged in the magazine, said slider adapted and arranged to reciprocate been a lower position and an upper position, wherein the slider is preferably associated with a biasing spring which biases the slider to the lower position. Preferably the extractor, when introduced in the cartridge, abuts the slider and pushes it upwardly. The rods on one side of the magazine will rest against the slider. Due to friction between said rods and the slider some of the rods will be carried along with the movement of the slider, whereby the stack of rods inside the magazine is agitated and the rods drop towards the exit under influence of gravity.

In a further embodiment the slider has a rod facing surface, said surface having an agitation feature adapted to agitate the rods stacked in the magazine, such that the rods go down in the cartridge when a rod is discharged from the cartridge. Preferably the agitation feature comprises a recess, adapted to receive one or more rods which are to be moved with the slider, thereby agitating the rods in the magazine. The agitation feature improves and facilitates that the rods are carried along with the slider, whereby the agitation and thereby the dropping of rods towards the exit is improved.

In a further embodiment the apparatus further comprises an erecting lever, which is pivotably connected to the feeding device and adapted to receive an individual rod from the feeding device in a lying orientation, and which erecting lever is pivotable to an upstanding position in which it is aligned or align able with the printhead to feed the rod to the printhead. The rods have a substantially horizontal orientation inside the cartridge and exit the cartridge in this horizontal or “lying” orientation. To be able to feed the rod to the printhead in an upstanding, or substantially vertical orientation, the erecting lever is foreseen, which receives a lying rod and then rotate to an upstanding position, thereby bringing the rod to an upstanding position.

In a further embodiment the feeding device has an elongate ejection port which is adapted to discharge the rods in a direction orthogonal to the longitudinal axis of the rod into the erecting lever.

In a further embodiment a rod detection sensor is arranged at the ejection port. The rod detection sensor is connected with a control system that controls the actuating mechanism. If the detection sensor does not detect a rod exiting the ejection port while the actuating mechanism has been activated, a failure is detected, and the control system triggers a retry. If the detection sensor does detect a successful ejection of a rod, the control system can change the registered number of rods remaining in the cartridge reduced by one. In this way the system knows how many rods are still stored and when a cartridge must be replaced.

The invention also relates to a cartridge as described in the above, which is adapted to be placed on a feeding device of an apparatus for forming a three-dimensional object by additive manufacturing, in particular extrusion based modelling, wherein said cartridge contains rods of solid modelling material.

The invention will be further elucidated in the following detailed description with reference to the drawings.

### BRIEF DESCRIPTION OF THE DRAWINGS

FIG. 1 shows an isometric view of an assembly of a cartridge and a feeding device for an apparatus according to the invention in a feeding state;

FIG. 2 illustrates how the cartridge is placed on the feeding device;

FIG. 3 shows a cross section of the cartridge in a state in which it is not placed on the feeding device;

FIG. 4 shows a docking section of the feeding device in a view in perspective form above;

FIG. 5 shows a top elevational view of the feeding device;

FIG. 6 shows a cross section of the docking section of the feeding device with an empty cartridge placed in the docking section;

FIG. 7 shows a similar cross section as FIG. 6, which illustrates the individualising of a rod from the stack of rods in the cartridge;

FIG. 8 shows a similar cross section which illustrates the release of a rod from the cartridge in an erecting lever;

FIG. 9 shows an isometric view of an assembly of a cartridge and a feeding device for an apparatus according to the invention in a receiving state;

FIG. 10 illustrates the feeding of a rod from the assembly of FIG. 1 to a printhead;

FIG. 11 shows an exploded view of the cartridge; and

FIG. 12 shows the assembly of FIG. 1 from the other side.

### DETAILED DESCRIPTION OF THE INVENTION

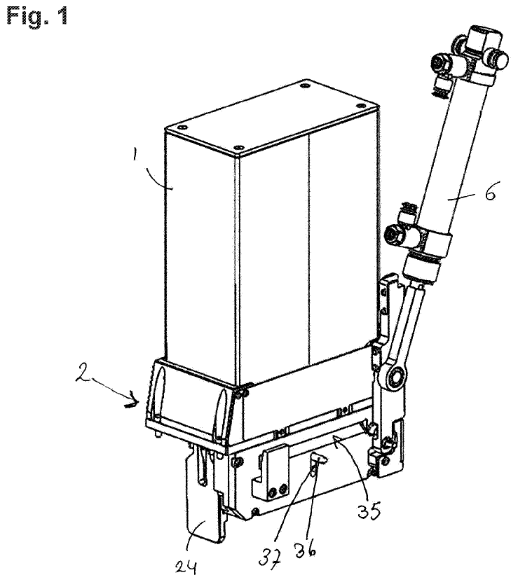

In FIG. 1 is shown a cartridge 1 containing rods of solid modelling material which is placed on a feeding device 2 adapted to feed the rods of modelling material from the cartridge 1 to a printhead of an apparatus for forming a three-dimensional object by additive manufacturing, e.g. a 3D printer.

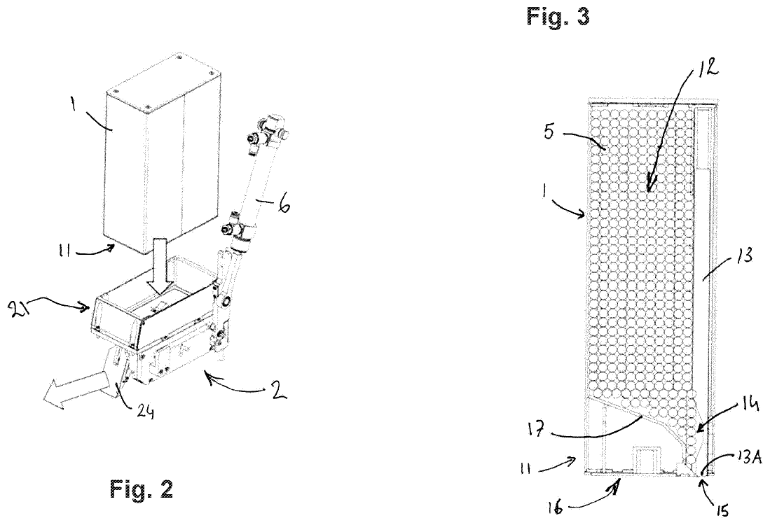

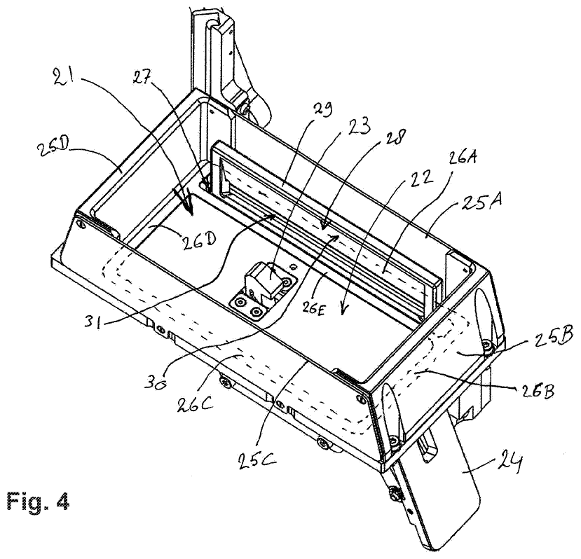

FIG. 2 illustrates how the cartridge 1 is placed on the feeding device 2. The feeding device 2 comprises a docking section 21. The cartridge 1 has a discharging end 11. The docking section 21 of the feeding device 2 is adapted to receive the discharging end 11 of the cartridge 1. FIG. 4 shows the docking section 21 of the feeding device 2 in more detail and in another view. The cartridge 1 is fixed on the feeding device 2 by means of a latch 23 engaging an opening in a bottom of the cartridge 1. The latch 23 can be operated by the user placing/replacing the cartridge by means of an operating lever 24. The latch 3 and the operating lever 24 are for example connected by a linkage mechanism.

FIG. 3 shows a cross section of the cartridge 1, which is filled with rods 5 of modelling material. The cartridge 1 comprises a magazine 12 in which the rods 5 are stacked in a parallel fashion as is visible in FIG. 3. The rods 5 are oriented substantially horizontal when the cartridge 1 is placed on the feeding device 2 (cf. FIG. 1). One advantage of the horizontal orientation of the rods in the use modus is that the movement of the rods towards the discharge end of the cartridge can be gravity based, which prevents the necessity of an actively controlled push mechanism to move the rods within the magazine 12 towards the discharge end 11 which includes a cartridge outlet 15 from which rods can exit the cartridge 1.

A slanting support surface 17 is arranged in the cartridge 1 to form a lower end of the magazine 12. When the cartridge 1 is in the upright position as shown in FIG. 3, the rods 5 in the magazine 12 will be guided in the direction of the outlet 15.

The rods are made of modelling material such as PEEK. In the embodiment shown in the figures the cartridge 1 can contain about 300 rods 5. The rods 5 are preferably dried before they are stored in the cartridge 1. This can be done by placing the rods in a drying oven. In the drying oven the rods can be maintained at a certain drying temperature above 100° C., for example around 180° C. for a certain time, e.g. 2 hours. After drying the rods can be placed in the cartridge 1.

Another option is to place a cartridge 1 filled with rods in a drying oven. The cartridge housing is in such case not yet closed/sealed, such that the moisture can escape. The cartridge is adapted to withstand the temperature in the drying oven. The cartridge housing is sealed after the drying. The seal prevents air and moist from entering the magazine 12, where such air and moist can deteriorate the quality of the modelling material for 3D modelling purposes. For example, PEEK rods are hygroscopic and they will absorb moisture from the air over time.

As illustrated in FIG. 11, the cartridge 1 may furthermore contain a desiccant to absorb moist that eventually enters the cartridge 1. The cartridge 1 has an outer wall 9 and an inner wall 10 on opposite sides. Between the outer wall 9 and inner wall 10 a space is provided in which packages 8 of desiccant are arranged. The rods 5 (not shown in FIG. 11) extend with their longitudinal axis in the magazine 12 between the two inner walls 10. Slots 7 are provided in the inner wall 10 such that air in the magazine 12 can flow through the slots 7 towards the desiccant packages 8 and moist present in the air can be absorbed by the desiccant.

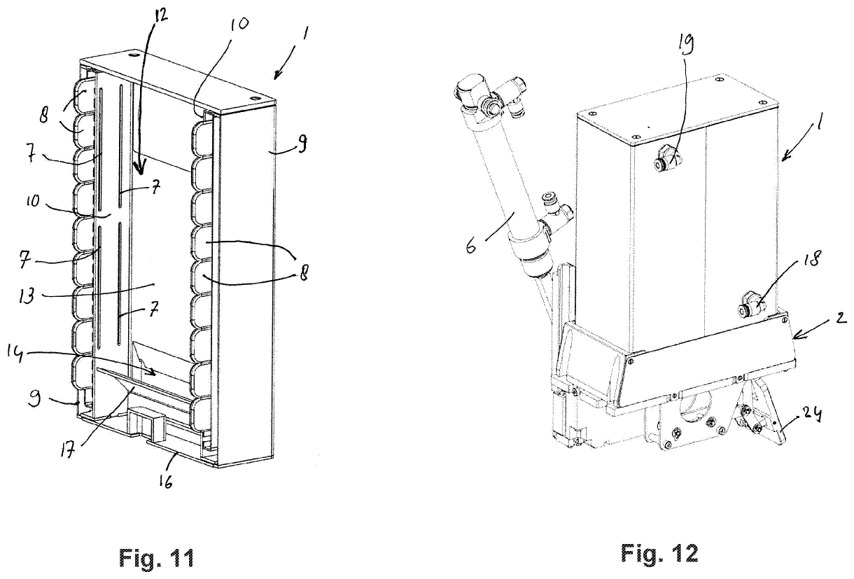

Another possible feature of the cartridge, which is shown in FIG. 12 is that the cartridge 1 is adapted to be flushed with dry gas. The cartridge housing has an inlet connection 18 and an outlet connection 19. The inlet connection 18 is adapted to be connected to a dry gas source and allows dry gas to flow from such a gas source into the magazine 12. The outlet connection 19 is adapted to be connected to a gas outflow and allows the gas to flow from the magazine to the gas outflow. The dry gas can be fed intermittently or continuously to the cartridge 1. The dry gas purges the moist and air from the magazine 12 and facilitates to keep the rods 5 dry.

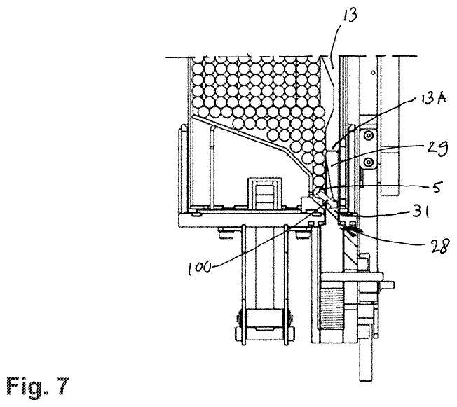

A movable slider 13 is arranged in the magazine 12. In this particular embodiment the slider 13 is arranged along one side of the cartridge 1, in FIG. 3 on the right. The slider 13 is embodied as a plate-like body, which forms a sort of lateral support wall for the stacked rods 5 in the magazine 12. The slider 13 can reciprocate between a lower position, which is shown in FIG. 3, and an upper position (cf. FIG. 7). A biasing spring (not shown) is connected with the slider 13 which biases the slider 13 to the lower position. Thus, in the state wherein the cartridge 1 is not placed on the feeding device 2, the slider 13 is in the lower position shown in FIG. 3.

The slider 13 has a recess 14 adapted to receive one or more rods 5 which are to be moved with the slider 13. When the slider 13 is moved up and down within the magazine 12 the rods 5 received in the recess 14 move up and down as well and the rest of the rods 5 stacked in the magazine 12 are agitated to prevent blockages from forming when they are dropping towards the outlet 15 as will be described further below.

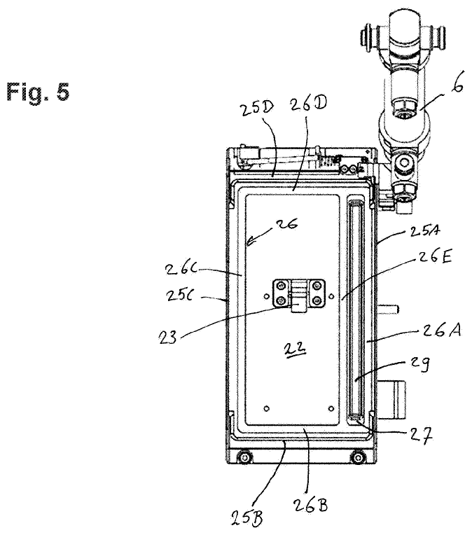

As is shown in FIGS. 4 and 5, the docking section 21 of the feeding device 2 has a bottom 22 and upstanding walls 25A-25D along the periphery of the bottom 22. In the embodiment shown in the figures the bottom 22 has substantially a rectangular shape. On the upwardly facing side of the bottom 222 a continuous sealing strip 26 is provided, which may be made of rubber or another suitable sealing material. The continuous sealing strip 26 has sealing strip sections 26A-26D which extend on the bottom 22 along an inner side of the walls 25A-25D respectively. An additional sealing strip section 26E extends from sealing strip section 26B to sealing strip section 26D.

In the bottom 22 an elongate slot-shaped gate 27 is provided. The gate 27 is located between the longitudinal sealing strip sections 26A and 26E. Portions of the transverse sealing strip sections 26B and 26D adjoining the longitudinal sealing strip sections 26A and 26E complete the peripheral seal around the gate 27.

When the discharging end 11 of the cartridge 1 is placed in the docking section 21 of the feeding device 2, the bottom end surface 16 of the cartridge 1 is tightened into engagement with the sealing strip sections 26A-26E. This provides a tight and continuous sealing between the bottom end surface 16 of the cartridge 1 and the bottom 22 of the docking section 21 of the feeding device 2, whereby air and moist cannot reach the cartridge outlet 15. The outlet 15 can thus be opened without air and moist being able to reach the outlet from the side of the upstanding walls 25A-25D.

The feeding device 2 has an extractor 28. The extractor 28 comprises an elongate wall member 29 which can move upwardly and downwardly through the gate 27. In FIG. 4 the wall member 29 of the extractor 28 is shown in an upward position, in which it extends from the gate 27 in the docking section 21 of the feeding device 2. The cartridge 1 has an outlet 15, which is aligned with the gate 27 of the feeding device 2 when the cartridge 1 is placed on the feeding device 2. The wall member 29 is adapted to be inserted in the cartridge 1 through the outlet 15, which has a similar elongate slot-like shape as the gate 27. Upon insertion of the wall member 29 in the cartridge 1 the upper end of the wall member 29 abuts a lower end 13A of the slider 13 and forces the slider upwardly, thereby moving the lower end 13A of the slider 13 away from the cartridge outlet 15.

The wall member 29 has an oblique surface which faces the rods 5 when it is inserted in the cartridge 1. Thereby a recess 30 is formed in the wall member 29 in which rods 5 can enter. At a lower end of the recess 30 a rod chamber 31 is formed, which is adapted to receive one individual rod 5. An arrow 100 in FIG. 7 illustrates the movement of a rod 5 towards the rod chamber 31, when the extractor 28 is inserted in the cartridge 1.

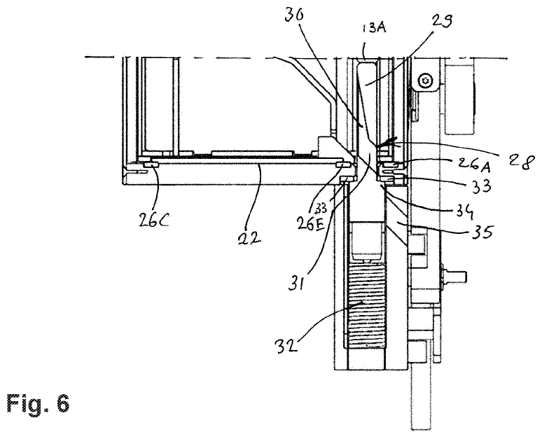

At least one compression spring 32 engages the extractor 28 from below and biases the extractor 28 upwardly so as to extend into the cartridge 1. A downwardly facing peripheral area around the gate 27 forms a stop surface around the gate 27. A seal 33, e.g. a rubber seal, is provided on the stop surface. The extractor 28 has a shoulder 34 formed on it (cf. FIG. 6). The compression springs 32 bias the shoulder 34 into tight engagement with the seal 33 on the stop surface. Thereby an airtight/watertight seal is provided such that air and moist cannot enter the cartridge through the gate 27 and the cartridge outlet 15.

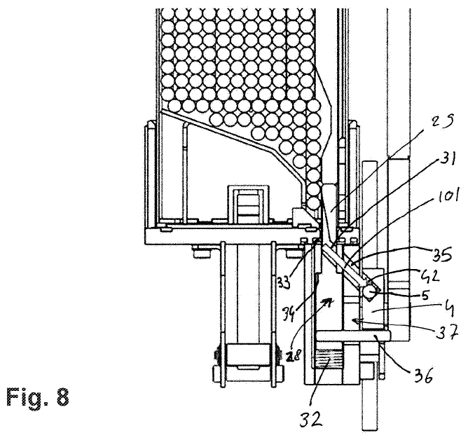

The feeding device 2 has an elongate ejection port 35, which is visible in FIG. 1. When a rod 5 is received in the rod chamber 31, the extractor 28 is movable to a discharge position, which is illustrated in FIG. 8. In the discharge position the extractor 28 is partially withdrawn from the gate 27 and the rod chamber 31 is aligned with the ejection port 35. The rod 5 in the rod chamber 31 is moved from the magazine 12 through the gate 27 and is allowed to be discharged through the ejection port 35 of the feeding device 2. In this state the airtight seal is temporarily broken, for example for 2 seconds, because the shoulder 34 moves away from the seal 33.

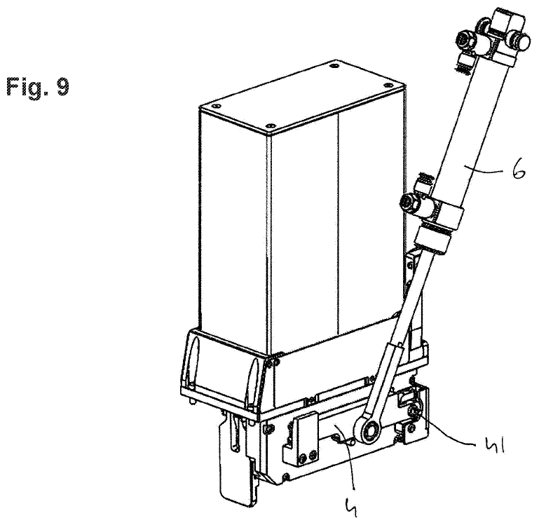

An erecting lever 4 is pivotably connected to the feeding device 2 by a pivot 41 and adapted to receive an individual rod 5 from the feeding device 2 in a substantially horizontal orientation. In FIG. 9 the situation is shown in which the erecting lever 4 is in the receiving position. The erecting lever 4 has an elongate receiving recess 42 which in the receiving position is aligned with the ejection port 35 of the feeding device 2. This state is also shown in FIG. 8, which illustrates with arrow 101 that the rod 5 rolls sideways obliquely downwardly from the rod chamber 31 through the ejection port 35 into the receiving recess 42 of the erecting lever 4.

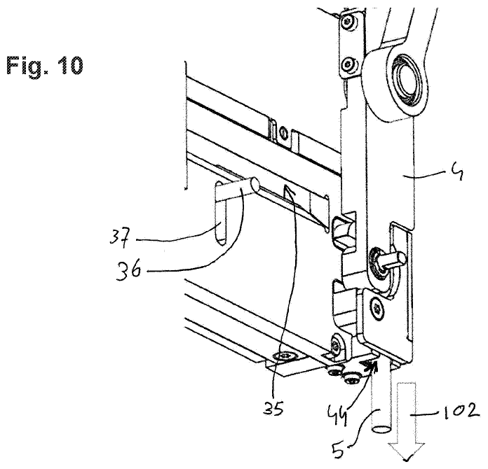

The erecting lever 4 is pivotable to an upstanding position by an actuator 6, in this case embodied as a pneumatic cylinder. The erecting lever 4 has an outlet port 44 from which the rod 5 can be ejected in a longitudinal direction as is illustrated by arrow 102 in FIG. 10. In the upstanding position, shown in FIGS. 1 and 10 the outlet port 44 is on the underside of the erecting lever 4 and it can be aligned with a printhead to feed the rod 5 to the printhead.

Thus, the feeding device 2 has an elongate ejection port 35 which is adapted to discharge the rods 5 in a direction orthogonal to the longitudinal axis of the rod 5 into the erecting lever 4. The erecting lever 4, moved by the actuator 6, transfers the rod 5 from a horizontal position towards an upstanding, e.g. a vertical position, in which it can be fed from above into a printhead.

The extractor 28 is rigidly connected to a pin 36 which extends through a slotted hole 37 in the housing of the feeding device 2, as is best visible in FIGS. 1 and 10. When the erecting lever 4 is swivelled down by the actuator 6 to the receiving position, the erecting lever 4 engages the actuating pin 36 and pushes it down. Thereby the extractor 28 is moved down contrary to the force of the compression spring 32. The extractor 28, which moves down, transports an individual rod 5 from the magazine 12 of the cartridge 1 to the ejection port 35. When the rod chamber 31 of the extractor 28 is aligned with the ejection port 35, the receiving recess 42 of the erecting lever 4 is aligned on the other side with the ejection port 35. In this state the rod 5 can roll obliquely downward from the rod chamber 31 through the ejection port into the receiving recess 42.

When the erecting lever is swivelled upwardly to the upstanding position by the actuator 6, the compression springs 32 push the extractor 28 and the pin 36 to an upward position again, in which the sealing action between the shoulder 34 and the seal 33 is restored again.

The cartridge 1 may typically be supplied in a sealed bag, such that the content of the cartridge 1 is hermetically sealed from environmental air and moist. When the cartridge 1 is removed from the bag and placed immediately on the docking section of the feeding device 2, the seal 26 cooperating with the bottom 16 of the cartridge 1 and the seal 33 cooperating with the shoulder 34 of the extractor maintain an airtight seal. Only when an individual rod is moved by the extractor 28 towards the ejection port 35, the shoulder 34 is briefly, for example 2 seconds, disengaged from the seal 33, and there is no airtight seal. However, this is sufficient to keep the rods 5 of modelling material dry enough to warrant a sufficient quality of the printed objects. Moreover, the cartridge may contain desiccant to counteract the effect of the small amount of air carrying moisture entering the cartridge at this time.

What is claimed is:

1. An apparatus for forming a three-dimensional object by additive manufacturing, in particular extrusion based modelling, said apparatus comprising:
a printhead for depositing modelling material,
a base constituting a support for the three-dimensional object to be printed by the printhead,
wherein the printhead and the base are moveable with respect to each other for positioning and moving the printhead with respect to the base to form the three-dimensional object,
said apparatus furthermore comprising:
a cartridge containing rods of solid modelling material,
a feeding device adapted to feed the rods of modelling material from the cartridge to the printhead,
wherein the cartridge is adapted to be placed on the feeding device.

2. The apparatus according to claim 1, wherein the feeding device comprises a docking section and wherein the cartridge has a discharging end, wherein the docking section is adapted to receive the discharging end of the cartridge.

3. The apparatus according to claim 2, wherein the docking section of the feeding device and/or the discharging end of the cartridge comprises a seal which seals the interior of the cartridge from the environmental air.

4. The apparatus according to claim 1, wherein the rods are dried.

5. The apparatus according to claim 1, wherein the cartridge furthermore contains a desiccant.

6. The apparatus according to claim 1, wherein the cartridge is adapted to be flushed with dry gas.

7. The apparatus according to claim 1, wherein the apparatus has a discharge mechanism that is operable by an actuating mechanism on the feeding device to discharge rods individually from the cartridge.

8. The apparatus according to claim 7, wherein the apparatus comprises an air lock, said air lock having a closed state in which it seals the interior of the cartridge from the environment, and said airlock having a temporary open state when the actuating mechanism of the feeding device discharges a rod from the cartridge.

9. The apparatus according to claim 8, wherein the discharge mechanism comprises a movable extractor on the feeding device and a gate on the feeding device, and wherein the cartridge has a cartridge outlet which is aligned with the gate when the cartridge is placed on the feeding device, wherein the movable extractor is introduced in the cartridge through the gate and through the cartridge outlet when the cartridge is placed on the feeding device, said movable extractor comprising a rod chamber to extract an individual rod from the cartridge.

10. The apparatus according to claim 9, wherein the airlock comprises a stop surface surrounding the gate and a shoulder formed on the extractor, said shoulder being adapted to engage the stop surface when the extractor is introduced through the gate, and wherein the airlock furthermore comprises a seal provided on the stop surface or the shoulder to seal the gate in an airtight manner when the extractor is introduced through the gate.

11. The apparatus according to claim 10, wherein the feeding device includes a compression spring which biases the extractor so as to extend into the cartridge and to bias the shoulder of the extractor towards the stop surface.

12. The apparatus according to claim 9, wherein the extractor is movable to a discharge position, in which the extractor is at least partially withdrawn from the gate whereby a rod received in the rod chamber is moved through the gate and is allowed to be discharged through the ejection port of the feeding device, and in which the airlock is in the temporarily open state.

13. The apparatus according to claim 12, wherein the actuator mechanism includes an actuating member which is connected to the movable extractor, which actuating member is adapted to be pushed down so as to push the extractor to the discharge position.

14. The apparatus according to claim 1, wherein the cartridge comprises a magazine in which the rods are stacked in a parallel fashion, and wherein the rods are oriented substantially horizontal when the cartridge is placed on the feeding device.

15. The apparatus according to claim 14, wherein a movable slider is arranged in the magazine, said slider adapted and arranged to reciprocate been a lower position and an upper position, wherein the slider is preferably associated with a biasing spring which biases the slider to the lower position.

16. The apparatus according to claim 15, wherein the extractor, when introduced in the cartridge, abuts the slider and pushes it upwardly.

17. The apparatus according to claim 15, wherein the slider has a rod facing surface, said surface having an agitation feature adapted to agitate the rods stacked in the magazine, such that the rods go down in the cartridge when a rod is discharged from the cartridge.

18. The apparatus according to claim 17, wherein the agitation feature comprises a recess, adapted to receive one or more rods which are to be moved with the slider, thereby agitating the rods in the magazine.

19. The apparatus according to claim 1, wherein the apparatus further comprises an erecting lever, which is pivotably connected to the feeding device and adapted to receive an individual rod from the feeding device in a lying orientation, and which erecting lever is pivotable to an upstanding position in which it is aligned or alignable with the printhead to feed the rod to the printhead.

20. The apparatus according to claim 19, wherein the feeding device has an elongate ejection port which is adapted to discharge the rods in a direction orthogonal to the longitudinal axis of the rod into the erecting lever.

21. The apparatus according to claim 20, wherein the feeding device comprises a rod detection sensor configured and arranged to detect if a rod passes through the ejection port.

22. The apparatus according to claim 1, wherein the cartridge is adapted to be placed in a drying oven to dry the rods.

23. A cartridge adapted to be placed on a feeding device of an apparatus for forming a three-dimensional object by additive manufacturing, in particular extrusion based modelling, said cartridge containing rods of solid modelling material,
a) wherein the cartridge is hermetically sealed, or
b) wherein the cartridge has a discharging end comprising a seal or a discharging end which is adapted to cooperate with a seal provided on the feeding device, to seal the interior of the cartridge from environmental air, or
c) wherein the cartridge is adapted to be flushed with dry gas, or
d) wherein the cartridge is adapted to be placed in a drying oven to dry the rods.

24.-26. (canceled)

27. The cartridge according to claim 23, wherein the cartridge furthermore contains a desiccant.
